(19) United States
(12) Patent Application Publication
(10) Pub. No.: US 2024/0127030 A1
(43) Pub. Date: Apr. 18, 2024

(54) MACHINE LEARNING SYSTEMS AND METHODS FOR CLASSIFICATION

(71) Applicant: Samsung Display Co., Ltd., Yongin-si (KR)

(72) Inventors: Qisen Cheng, San Jose, CA (US); Shuhui Qu, San Jose, CA (US); Kaushik Balakrishnan, San Jose, CA (US); Janghwan Lee, San Jose, CA (US)

(21) Appl. No.: 18/109,710

(22) Filed: Feb. 14, 2023

Related U.S. Application Data
(60) Provisional application No. 63/379,239, filed on Oct. 12, 2022.
(60) Provisional application No. 63/416,861, filed on Oct. 17, 2022.

(51) Int. Cl. G06N 3/042; G06N 5/01

(52) U.S. Cl. CPC G06N 3/042; G06N 5/01

(57) ABSTRACT

A classification system includes: one or more processors; and memory including instructions that, when executed by the one or more processors, cause the one or more processors to: calculate reference Shapley values for features of a data sample based on a first classification model; and train a second classification model though multi-task distillation to: predict Shapley values for the features of the data sample based on the reference Shapley values and a distillation loss; and predict a class label for the data sample based on the predicted Shapley values and a ground truth class label for the data sample.

### CROSS-REFERENCE TO RELATED APPLICATION(S)

This application claims priority to and the benefit of U.S. Provisional Application No. 63/416,861, filed on Oct. 17, 2022, entitled “SHAPLEY-BASED TABULAR DEEP NEURAL NETWORK FOR CLASSIFICATION,” and also claims priority to and the benefit of U.S. Provisional Application No. 63/379,239, filed on Oct. 12, 2022, entitled “SHAPLEY-BASED TABULAR DEEP NEURAL NETWORK FOR CLASSIFICATION,” the entire content of all of which is incorporated by reference herein.

### BACKGROUND

### 1. Field

Aspects of embodiments of the present disclosure relate to machine learning classification systems and methods.

### 2. Description of Related Art

The television and mobile display industry has grown rapidly. As new kinds of display panels and production methods are being designed and used, enhanced equipment and quality control methods may be desired to maintain production quality. For example, defects in display panels may lead to increased costs and loss. However, some of the defects may be repairable, which may reduce the costs and loss when properly identified. Thus, sensory data may be gathered during the manufacturing processes of the display panels, and the sensory data may be analyzed to identify repairable and unrepairable defects.

The above information disclosed in this Background section is for enhancement of understanding of the background of the present disclosure, and therefore, it may contain information that does not constitute prior art.

### SUMMARY

Embodiments of the present disclosure are directed to machine learning classification systems and methods, for example, such as machine learning classification systems and methods for tabular data.

According to one or more embodiments of the present disclosure, a classification system includes: one or more processors; and memory including instructions that, when executed by the one or more processors, cause the one or more processors to: calculate reference Shapley values for features of a data sample based on a first classification model; and train a second classification model though multi-task distillation to: predict Shapley values for the features of the data sample based on the reference Shapley values and a distillation loss; and predict a class label for the data sample based on the predicted Shapley values and a ground truth class label for the data sample.

In an embodiment, to calculate the reference Shapley values, the instructions may further cause the one or more processors to: generate masked data by substituting a subset of original feature values in the data sample with background values; and train a multilayer perceptron to output predictions on the masked data based on the first classification model. The reference Shapley values may be calculated based on the predictions output by the multilayer perceptron.

In an embodiment, the first classification model may be a decision-tree based model; and the multilayer perceptron may be trained on the masked data according to the decision-tree based model and a loss function.

In an embodiment, to train the second classification model to predict the Shapley values, the instructions may further cause the one or more processors to: estimate the Shapley values for the features of the masked data; and compare the estimated Shapley values with the reference Shapley values according to the distillation loss.

In an embodiment, to train the second classification model to predict the class label, the instructions may further cause the one or more processors to: estimate the class label for the data sample based on the estimated Shapley values; and compare the estimated class label with the ground truth class label according to a cross-entropy loss.

In an embodiment, the second classification model may include a plurality of fully connected layers with a linear activation function to be trained to predict the Shapley values based on the reference Shapley values and the distillation loss.

In an embodiment, the second classification model may include at least one fully connected layer to be trained to predict the class label based on the predicted Shapley values and a cross-entropy loss.

In an embodiment, the instructions may further cause the one or more processors to output the predicted Shapley values as explanations for the class label prediction.

According to one or more embodiments of the present disclosure, a method for classifying data includes: calculating, by one or more processors, reference Shapley values for features of a data sample based on a first classification model; and training, by the one or more processors, a second classification model though multi-task distillation to: predict Shapley values for the features of the data sample based on the reference Shapley values and a distillation loss; and predict a class label for the data sample based on the predicted Shapley values and a ground truth class label for the data sample.

In an embodiment, the calculating of the reference Shapley values may include: generating, by the one or more processors, masked data by substituting a subset of original feature values in the data sample with background values; and training, by the one or more processors, a multilayer perceptron to output predictions on the masked data based on the first classification model. The reference Shapley values may be calculated based on the predictions output by the multilayer perceptron.

In an embodiment, the first classification model may be a decision-tree based model; and the multilayer perceptron may be trained on the masked data according to the decision-tree based model and a loss function.

In an embodiment, the training of the second classification model to predict the Shapley values may include: estimating, by the one or more processors, the Shapley values for features of the masked data; and comparing, by the one or more processors, the estimated Shapley values with the reference Shapley values according to the distillation loss.

In an embodiment, the training of the second classification model to predict the class label may include: estimating, by the one or more processors, the class label for the data sample based on the estimated Shapley values; and comparing, by the one or more processors, the estimated class label with the ground truth class label according to a cross-entropy loss.

In an embodiment, the second classification model may include a plurality of fully connected layers with a linear activation function to be trained to predict the Shapley values based on the reference Shapley values and the distillation loss.

In an embodiment, the second classification model may include at least one fully connected layer to be trained to predict the class label based on the predicted Shapley values and a cross-entropy loss.

In an embodiment, the method may further include outputting, by the one or more processors, the predicted Shapley values as explanations for the class label prediction.

According to one or more embodiments of the present disclosure, a classification system includes: a first machine layer perceptron to be trained to output predictions on first masked data of a first data sample during a first training based on a first classification model; a first guideline generator to be trained to calculate reference Shapley values based on the predictions by the first machine layer perceptron during the first training; and a second classification model to be trained though multi-task distillation during the first training to: predict Shapley values for features of the first masked data based on the reference Shapley values and a distillation loss; and predict a class label for the first data sample based on the predicted Shapley values and a ground truth class label for the first data sample.

In an embodiment, the second classification model may include: a plurality of fully connected layers with a linear activation function to be trained to predict the Shapley values based on the reference Shapley values and the distillation loss; and at least one fully connected layer to be trained to predict the class label based on the predicted Shapley values and a cross-entropy loss.

In an embodiment, the classification system may further include: a second machine layer perceptron to be trained to output predictions on second masked data of a second data sample during a second training based on the first classification model; and a second guideline generator to be trained to calculate reference Shapley values based on the predictions by the second machine layer perceptron during the second training. The second data sample may include data that is different from data of the first data sample, and the second training may be subsequent in time from the first training.

In an embodiment, the second classification model may be configured to be retrained though multi-task distillation for predicting the Shapley values and the class label during the second training based on the reference Shapley values output by the first and second guideline generators according to the first and second machine layer perceptrons, and a ground truth class label for the second data sample.

### BRIEF DESCRIPTION OF THE DRAWINGS

The above and other aspects and features of the present disclosure will be more clearly understood from the following detailed description of the illustrative, non-limiting embodiments with reference to the accompanying drawings, in which:

FIG. 1 is a block diagram of a classification system according to an embodiment;

FIG. 2 is a block diagram of a method for training a classification system according to an embodiment;

FIG. 3 is a flow diagram of a method for training a classification system according to an embodiment;

FIG. 4 is a flow diagram of a method for generating a guideline generator from a first classification model according to an embodiment;

FIG. 5 is a flow diagram of a method for training a second classification model according to an embodiment;

FIG. 6 is a graph illustrating model decision explanations output by a second classification model according to an embodiment;

FIG. 7 is a chart schematically illustrating a method for adapting to data drift according to an embodiment; and

FIG. 8 is a flow diagram of a method for continual learning for a classification system according to an embodiment.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

Generally, due to difficulties of capturing small defects using computer vision methods and models alone, sensory data gathered during the manufacturing processes of display panels may typically be provided in the form of tabular data. For example, the tabular data may include the sensory data in the form of measurement values generated using various sensors during various manufacturing processes of a corresponding display panel, such that the measurement values may be analyzed to classify repairable and unrepairable defects (e.g., wire defects, line defects, pixel defects, layer thickness defects, coverage defects, connection defects, short-circuit defects, open-circuit defects, and the like) of the corresponding display panel. Accordingly, machine learning methods and models that are highly accurate in classifying repairable and unrepairable defects, provide qualitative and quantitative explanations for model decisions during training, and adapt to continuously learn from new data in a deployment environment may be desired, in order to minimize or reduce the costs that may be incurred as a result from inaccurately classifying a defect as being unrepairable.

While decision-tree based models and the like, such as Gradient-Boosted Decision Tree (GBDT) based models, may provide high accuracy in classifying tabular data (e.g., such as the sensory data), incremental updates thereto may be prohibitively costly and time consuming. For example, as the equipment and/or quality control methods are enhanced, or as another example, as the current equipment wears down through successive use, variations in the tabular data (e.g., such as data drift) may occur due to the differing conditions. In this case, incremental updates may be periodically needed in order to appropriately classify the new data (e.g., the tabular data including the variations or drift data), but such incremental updates to decision-tree based models may be difficult due to their tree-like characteristics.

Deep neural network models provide a natural framework for being incrementally updated, and thus, may be desirable for periodical retraining based on the new data. However, it may be difficult and costly to maintain all of the data needed to preserve performance on the old data (e.g., the original training data and/or all historical data), while updating (e.g., training) the deep neural networks on the new data. Further, classification predictions by deep neural networks may not be as accurate as those of the decision-tree based models, and it may be more difficult to generate qualitative and quantitative explanations from deep neural networks than from the decision-tree based models.

For example, decision-tree based models may be understood as essentially being rule-based models (e.g., from a decision node, go to either one of two resulting leaf nodes), and thus, may be more accurate in making predictions on familiar datasets, while being easier to determine the features that have more of an impact on, or in other words, that more heavily influenced the predictions of such models. On the other hand, due to the weightage characteristics of loss functions used to train deep neural networks, it may be more difficult to determine the impact of the various different features, for example, such as those that more heavily influence the weights of the loss functions.

According to one or more embodiments of the present disclosure, a classification system may be provided that distills knowledge learned from a first classification method or model (e.g., an existing model or a prior model, such as a decision-tree based method or model) to train and/or retrain a second classification method or model (e.g., a neural network based method or model) to classify data, such as tabular data. For example, in some embodiments, Shapley-based guidance (e.g., reference Shapley values) may be obtained from a decision-tree based model to train a neural network based model through multi-task distillation. Through multi-task distillation, the neural network based model may be trained on two tasks, to predict a Shapley value for each feature of the data, and use the predicted Shapley values to predict a class label for the data. Accordingly, accuracy of the neural network based model may be improved based on guidance learned from the decision-tree based model.

According to one or more embodiments of the present disclosure, the second classification method or model (e.g., the neural network based model) may generate qualitative and quantitative explanations for the model's predictions in one forward pass during model training, rather than generating the explanations in additional post hoc processes after the model training. For example, in some embodiments, the Shapley value predictions by the neural network based model that are used for the classification predictions thereby may also be provided as the qualitative and quantitative explanations for the classification predictions by the model. Accordingly, computational costs may be reduced, and potential issues may be identified sooner.

According to one or more embodiments of the present disclosure, the second classification method or model (e.g., the neural network based model) may continually learn and adapt to new data (e.g., varying data or drifting data), without requiring all of the historical data to preserve the performance of the predictions on the historical data while being trained on the new data. For example, in some embodiments, multiple guideline generators may be obtained from the first classification method or model (e.g., the decision-tree based model), and accumulated over time. The multiple guideline generators may be trained based on the historical data over time to provide the Shapley-based guidance (e.g., the reference Shapley values) on various feature combinations of the historical data, such that the knowledge learned by the accumulated guideline generators may be used to train the neural network based model on the new data, without the need for all of the historical data. Accordingly, costs, resources, and complexity for incrementally updating the second classification method or model based on the new data may be reduced.

While some aspects and features of the present disclosure have been briefly described above, the present disclosure is not limited thereto, and additional aspects and features of the present disclosure may be realized from the description that follows with reference to the figures, or may be learned by practicing one or more of the presented embodiments of the present disclosure. The above and other aspects and features of the present disclosure will now be described in more detail hereinafter with reference to the accompanying figures.

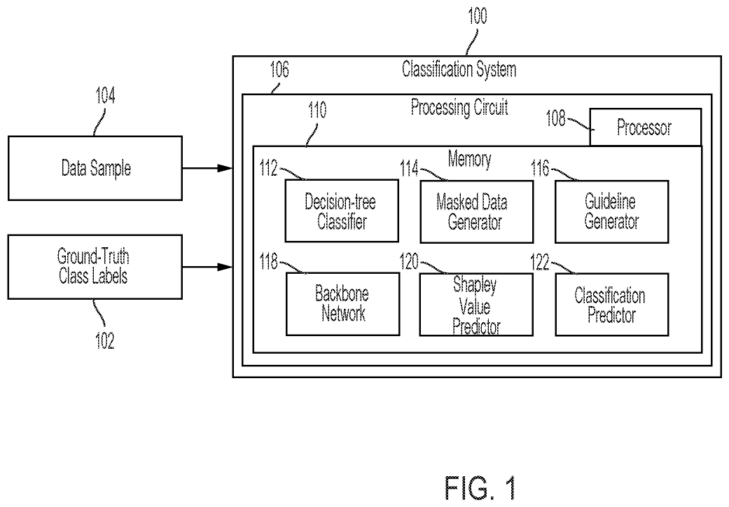

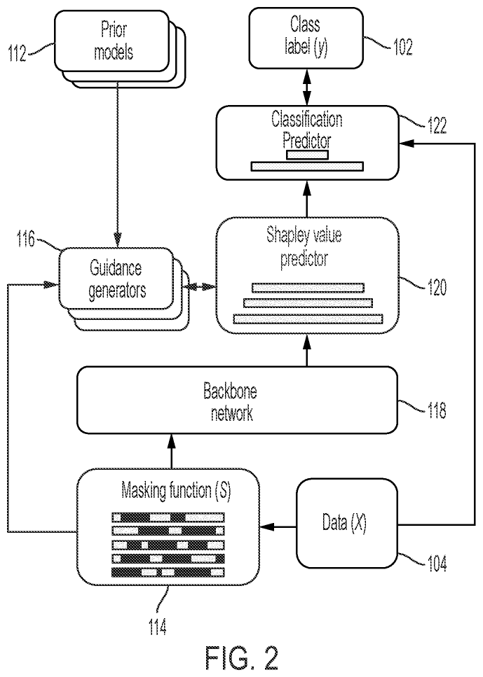

FIG. 1 is a block diagram of a classification system 100 according to an embodiment. FIG. 2 is a block diagram of a method for training the classification system 100 according to an embodiment.

In brief overview, the classification system 100 may include a first classification method or model (e.g., a decision-tree classifier 112), a second classification method or model (e.g., a Shapley value predictor 120 and a classification predictor 122), and one or more guideline generators 116, each of which are shown as instructions/computer code/data stored in memory 110 and executable by one or more processors 108 and/or one or more processing circuits 106. The first classification method or model may be an existing or prior classification method or model, for example, such as GBDT based models, used to classify tabular data, for example, such as to classify sensory data into repairable and unrepairable defects. The guideline generators 116 may be obtained from the first classification method or model to generate reference Shapley values based on the predictions (e.g., the classifications) by the first classification method or model.

The second classification method or model may be a deep neural network based model, and may be trained using the guideline generators 116 obtained from the first classification method or model. For example, the second classification method or model may be trained through multi-task distillation to predict Shapley values based on the reference Shapley values output by the guideline generators 116 (e.g., according to a loss function therebetween), and predict class labels based on the predicted Shapley values and ground truth class labels 102 (e.g., according to a loss function between the predicted and ground truth class labels). In other words, the second classification method or model may be understood as distilling the knowledge learned from the first classification method or model during training.

For example, as understood in the art of game theory, where the object is to fairly distribute payoffs to each player who collaborate in a game to achieve a desirable outcome, the Shapley value for each individual player may be calculated based on the player's contribution to the outcome, and used to fairly distribute the payoff to the player. In the context of machine learning, the Shapley value is the measure of the impact of each feature on a prediction by looking at the difference between predictions made with and without the feature. According to embodiments of the present disclosure, as used herein, the Shapley value of each feature may be output as a probability (e.g., a percentage or a value) of the feature's potential impact on the predictions of the class labels.

In other words, according to embodiments of the present disclosure, the reference Shapley values output by the guideline generators 116 may be understood as kind of ground truth values that maybe used to train the second classification method or model (e.g., the Shapley value predictor 120) to calculate a loss function between its predicted Shapley values and the reference Shapley values, in order to more accurately predict the Shapley values during inference for data in a production environment (e.g., without the benefit of the reference Shapley values generated by the guideline generators 116). The Shapley values predicted by the second classification method or model may be used (e.g., by the classification predictor 122), for example, to adjust its predictions by weighting different feature values during training or inference.

In more detail, referring to FIGS. 1 and 2, during training, the classification system 100 may receive a data sample 104 and a ground-truth (e.g., ground-truth class labels 102). For example, the data sample 104 may include tabular data corresponding to sensory data captured by one or more sensors during one or more manufacturing processes of a display panel. However, the present disclosure is not limited thereto, and the data sample 104 may include any suitable data in any suitable format to be classified by the classification system 100. In some embodiments, the ground-truth may include ground-truth class labels 102 corresponding to a target class label or a target value for the predictions (e.g., the classifications) by the classification system 100. For example, in some embodiments, the ground-truth class labels 102 may be compared with the predicted class labels according to a loss function (e.g., to minimize or reduce a difference therebetween).

In some embodiments, the classification system 100 may include one or more processing circuits 106 including one or more processors 108 and memory 110. Each of the processors 108 may be a general purpose processor or specific purpose processor, an application specific integrated circuit (ASIC), one or more field programmable gate arrays (FPGAs), a group of processing components, or other suitable processing components. Each of the processors 108 may be integrated within a single device or distributed across multiple separate systems, servers, or devices (e.g., computers). For example, each of the processors 108 may be an internal processor with respect to the classification system 100, or one or more of the processors 108 may be an external processor, for example, implemented as part of one or more servers or as a cloud-based computing system. Each of the processors 108 may be configured to execute computer code or instructions stored in the memory 110, and/or received from other computer readable media (e.g., CDROM, network storage, a remote server, and/or the like).

The memory 110 may include one or more devices (e.g., memory units, memory devices, storage devices, and/or the like) for storing data and/or computer code for performing and/or facilitating the various processes described in the present disclosure. The memory 110 may include random access memory (RAM), read-only memory (ROM), hard drive storage, temporary storage, non-volatile memory, flash memory, optical memory, or any other suitable memory for storing software objects and/or computer instructions. The memory 110 may include database components, object code components, script components, and/or any other kinds of information structures for supporting the various activities and information structures described in the present disclosure. The memory 110 may be communicably connected to the one or more processors 108 via the one or more processing circuits 106, and may include computer code for executing (e.g., by the one or more processors 108) one or more processes described herein.

In some embodiments, the memory 110 may include the first classification method or model, the second classification method or model, a masked data generator 114, the guideline generators 116, and a backbone network 118. The first classification method or model may include a decision-tree classifier 112, and the second classification method or model may include a Shapley value predictor 120 and a classification predictor 122. While FIG. 1 illustrates, for convenience, that the decision-tree classifier 112, the masked data generator 114, the guideline generator 116, the backbone network 118, the Shapley value predictor 120, and the classification predictor 122 are stored as instructions/computer code/data in the memory 110, it is understood that they may be distributed across one or more devices of the memory 110 and/or one or more processing circuits 106 to be executed by the one or more processors 108.

For example, in various embodiments, the decision-tree classifier 112, the masked data generator 114, the guideline generator 116, the backbone network 118, the Shapley value predictor 120, and the classification predictor 122 may be implemented within a single device (e.g., a single computer, a single server, a single housing, and/or the like), or at least some thereof may be distributed across multiple devices (e.g., across multiple computers, multiple servers, multiple housings, and/or the like). In various embodiments, each of the decision-tree classifier 112, the masked data generator 114, the guideline generator 116, the backbone network 118, the Shapley value predictor 120, and the classification predictor 122 may include any suitable processor (e.g., one or more of the processors 108), memory (e.g., one or more memory devices of the memory 110), encoder-decoder pairs, logic devices, neural networks (e.g., fully connected neural networks (FCN), convoluted neural networks (CNN), recursive neural networks (RNN), and/or the like), controllers, circuits (e.g., integrated circuits (IC)), and/or the like to support the various functions, processes, activities, and/or the like described in the present disclosure.

In some embodiments, the decision-tree classifier 112 may generate class label predictions based on the first classification method or model (e.g., the prior model or the existing model), such as a decision-tree based model (e.g., GBDT and the like). In some embodiments, the masked data generator 114 may generate masked data from the data sample 104, which may be used to train one or more guideline generators 116 based on the decision-tree based model of the decision-tree classifier 112. For example, in some embodiments, the guideline generators 116 may be trained by the decision-tree classifier 112 based on the decision-tree based model to output reference Shapley values for any subset of features or combination of features of the masked data. In other words, the guideline generators 116 may be trained to provide amortized estimations of the reference Shapley values as decision guidelines (e.g., references on how each subset of features impacts the predictions based on the decision-tree based model) that are used to train the second classification method or model (e.g., the Shapley value predictor 120 and the classification predictor 122).

For example, in some embodiments, from a prior model f (e.g., the decision-tree based model), the decision-tree classifier 112 may generate a guideline generator g (e.g., from among the guideline generators 116) according to a masking function m(x, s) (e.g., of the masked data generator 114) that generates feature subsets, where x is a data sample and s is a subset (e.g., a random subset) of feature values, to output a reference Shapley value ϕ_{f} (e.g., g:m(x, s)→$).

In some embodiments, the masked data generator 114 may use the masking function m(x, s) to substitute the random subset s of original feature values in the data sample x (e.g., from among the data sample 104) with background values b, where b may be 0 or a mean value of each feature, according to an element-wise multiplication (e.g., by using a feature-wise multiplication) ⊙ to generate masked data M(x,s), for example, according to Equation 1.

M(x,s)=x⊙s+b⊙(1−s) Equation 1:

In some embodiments, because the original prior model f (e.g., the decision-tree based model) may not be able to generate predictions on the masked data, the guideline generator 116 may include a multilayer perceptron (MLP) β, as a “best effort” estimator that is trained based on the decision-tree based model (e.g., by the decision-tree classifier 112) to get approximated predictions on the masked data according to (e.g., by minimizing or reducing) a loss function L_{β}, for example, as shown in Equation 2.

L_{β}=Eₚ₍ₓ₎Eₚ₍ₛ₎[D_{KL}(f(x)∥p(y|m(x,s);β)] Equation 2:

In Equation 2, Eₚ₍ₓ₎ may correspond to an expectation for the sample x following a certain probability, Eₚ₍ₛ₎ may correspond to an expectation for the masked subset S of the masked data following a certain probability, D_{KL} may correspond to the statistical measurement of a difference between two distributions, f(x) may correspond to the prediction by the prior model f based on the sample x, and p(y|m(x,s); β) may correspond to the prediction on the subset of features of x, which is estimated by the MLP β.

In some embodiments, the reference Shapley values ϕ_{f} may be calculated by the generated guideline generator 116 based on the predictions of its trained MLP β on the masked data according to Equation 3.

ϕ_{f}=p(y|S;β)−p(y|Ø;β) Equation 3:

In Equation 3, p(y|S; β) may correspond to the prediction y by the MLP β with the masked subset S of random features of the masked data, and p(y|Ø; β) may correspond to the prediction y by the MLP β without the masked subset S.

In some embodiments, the reference Shapley values ϕ_{f} output by the generated guideline generator 116 based on the prior model f may be provided to the Shapley value predictor 120 to predict a Shapley value ϕ_{γ} for each feature of the masked data based on the reference Shapley values ϕ_{f} output by the guideline generators 116. For example, in some embodiments, the masked data generated by the masked data generator 114 according to the masking function described above may be provided to the backbone network 118. The backbone network 118 may include any suitable network configured to extract each of the features from the masked data, and provide the extracted features of the masked data to the Shapley value predictor 120. The Shapley value predictor may predict a Shapley value ϕ_{γ} for each of the features of the masked data (e.g., received from the backbone network 118), and may compare the predicted Shapley values ϕ_{γ} with the reference Shapley values ϕ_{f} output by the guideline generators 116 based on the prior model f to form a distillation loss used (e.g., to be reduced or minimized) during training.

In some embodiments, the Shapley value predictor 120 may include N fully connected (FC) layers with a linear activation function, where N may be a natural number. For example, in some embodiments, the Shapley value predictor 120 may include at least 3 (e.g., N≥3) FC layers with a rectified linear unit (ReLU) activation function. The Shapley value predictor 120 may predict the Shapley value ϕ_{γ} of each of the features in the masked data, and may compare the predicted Shapley values ϕ_{γ} with the references (e.g., the reference Shapley values (Pf based on the prior model f) from the guideline generator g (e.g., from among the guideline generators 116) to form the distillation loss L_{distill} to be minimized or reduced during the training of the second classification method or model, for example, as shown in Equation 4.

L_{distill}=Eₚ₍ₓ₎E_{U(y)}E_{p(S)}(g(s,x,y)−S^{T}ϕ_{γ}(x,y) Equation 4:

In equation 4, Eₚ₍ₓ₎ may correspond to an expectation for the sample x following a certain probability, E_{U(y)} may correspond to an expectation for a certain class label y following a uniform distribution, Eₚ₍ₛ₎ may correspond to an expectation for the masked subset S of the masked data following a certain probability, g(s,x,y) may correspond to Shapley-based guidelines by one or more guideline generators (e.g., the Shapley values ϕ_{f} output by the one or more guideline generators 116 based on the prior model), S^{T} may correspond to a transpose of the masked subset S, and ϕ_{γ}(x,y) may correspond to the Shapley values ϕ_{γ} predicted by the Shapley value predictor 120.

In some embodiments, the Shapley values ϕ_{γ} predicted on the masked data (e.g., including the masked features) by the Shapley value predictor 120 may be provided to the classification predictor 122, as well as the original data sample (e.g., data (x)) 104 that was used to generate the masked data. Accordingly, the classification predictor 122 may have insight into the Shapley values ϕ_{γ} predicted for each feature according to the masked data, as well as the actual data (e.g., data (x)) to be classified based on the ground truth (e.g., the ground-truth class labels 102). The classification predictor 122 may predict a class label based on the features (e.g., the feature values) of the actual data (e.g., data (x)) based on the Shapley value predictions ϕ_{γ} on the masked data, and may compare the predicted class labels with the ground-truth class labels 102 according to a loss function (e.g., to minimize or reduce the loss function).

In some embodiments, the classification predictor 122 may include at least one (e.g., one or two) FC layer(s) without a non-linear activation function. The classification predictor 122 may predict k-class probabilities ŷ for each sample, and compare the prediction ŷ with the ground-truth class label y (e.g., from among the ground-truth labels 102) according to a loss function be minimized or reduced during the training of the second classification method or model, for example, such as a cross-entropy loss function L_{CE} as shown in Equation 5.

L_{CE}=Σₖy^{(k)}·log(y^{(k)}) Equation 5:

In some embodiments, the second classification method or model (e.g., the Shapley value predictor 120 and the classification predictor 122) may be trained through multi-task distillation. For example, the Shapley value predictor 120 and the classification predictor 122 may jointly optimize the loss functions for their tasks of predicting the Shapley values and the class labels.

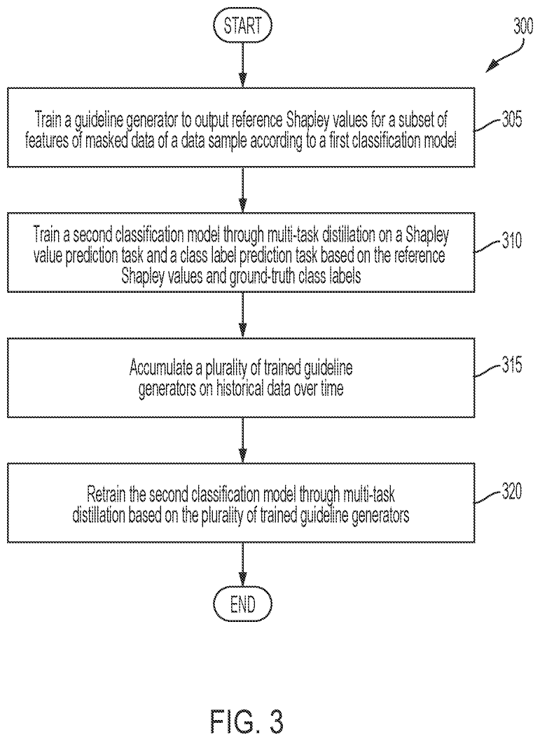

FIG. 3 is a flow diagram of a method 300 for training a classification system according to an embodiment. However, the present disclosure is not limited to the sequence or number of the operations of the method 300 shown in FIG. 3, and can be altered into any desired sequence or number of operations as recognized by a person having ordinary skill in the art. For example, in some embodiments, the order may vary, some processes thereof may be performed concurrently or sequentially, or the method 300 may include fewer or additional operations.

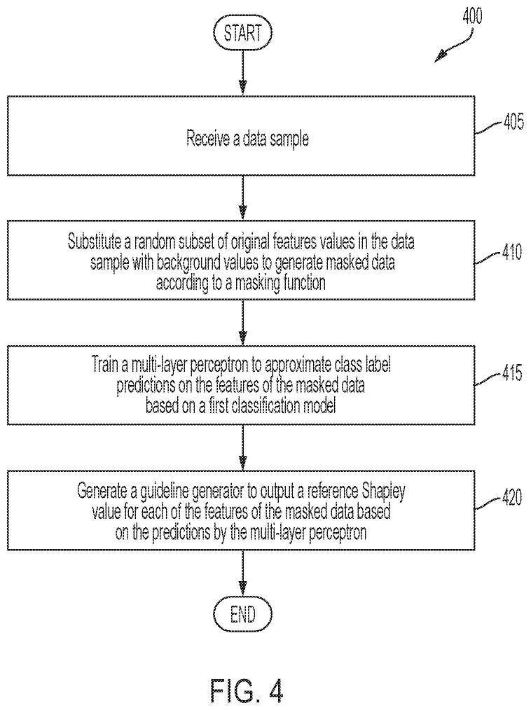

Referring to FIG. 3, a method 300 for training the classification system (e.g., such as the classification system 100 illustrated in FIGS. 1 and 2) may start, and a guideline generator is trained to output reference Shapley values for a subset of features of masked data of a data sample according to a first classification model at block 305. For example, in some embodiments, the guideline generator may include an MLP that is trained (e.g., by the decision-tree classifier 120) based on a decision-tree based model (e.g., GBDT) to output reference Shapley values on any subset or combination of features (e.g., masked features) of the masked data. Some embodiments in which a guideline generator is trained according to a first classification model are described in more detail below with reference to FIG. 4.

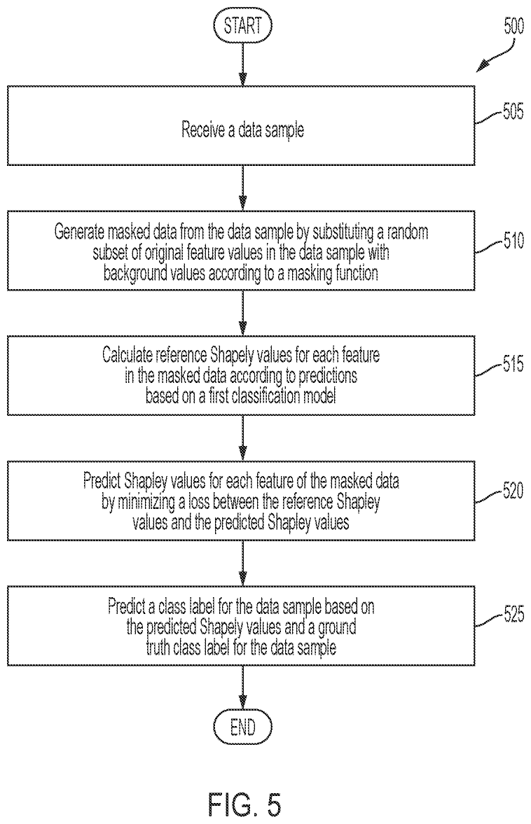

A second classification model is trained through multi-task distillation on a Shapley value prediction task and a class label prediction task based on the reference Shapley values and ground-truth class labels at block 310. For example, in some embodiments, the second classification model may include at least three FC layers that are trained to predict Shapley values for any subset of masked features based on the reference Shapley values output by the trained guideline generator (e.g., at block 305), and at least one (e.g., one or two) FC layer(s) that is trained to predict a class label for the data sample (e.g., from which the masked data is generated) based on the predicted Shapley values based on the masked data and the ground truth class labels. Some embodiments in which a second classification model is trained through multi-task distillation on a Shapley value prediction task and a class label prediction task are described in more detail below with reference to FIG. 5.

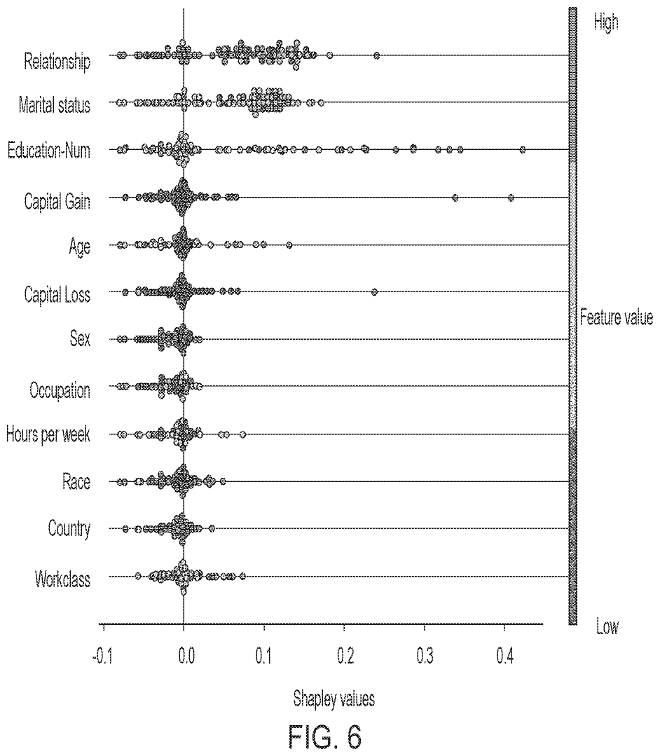

A plurality of trained guideline generators on historical data (e.g., historical production data samples) are accumulated over time at block 315. For example, in some embodiments, the second classification model may be periodically retrained as needed or desired on new data (e.g., varied data or drifting data), such that for each new training, a new guideline generator may be trained based on the first classification model to generate reference Shapley values on the new data (e.g., at the time) for the new training. The previously trained guideline generators based on the historical data (e.g., at each new training step) may be accumulated, and the second classification model may be retrained based on multi-task distillation according to the reference Shapley values output by the newly trained guideline generator (e.g., for the new training) and the previously trained guideline generators (e.g., based on the historical data). Accordingly, the second classification model is retrained through multi-task distillation based on the plurality of trained guideline generators at block 320, and the method 300 may end. Some embodiments in which the guideline generators trained on the historical data are accumulated over time are described in more detail below with reference to FIGS. 6 through 8.

FIG. 4 is a flow diagram of a method 400 for generating a guideline generator from a first classification model according to an embodiment. However, the present disclosure is not limited to the sequence or number of the operations of the method 400 shown in FIG. 4, and can be altered into any desired sequence or number of operations as recognized by a person having ordinary skill in the art. For example, in some embodiments, the order may vary, some processes thereof may be performed concurrently or sequentially, or the method 400 may include fewer or additional operations.

Referring to FIG. 4, the method 400 starts, and a data sample is received at block 405. For example, in some embodiments, the classification system 100 (e.g., see FIGS. 1 and 2) may receive the data sample 104 corresponding to tabular data (e.g., sensory data), but the present disclosure is not limited thereto. The data sample 104 may be training data used to originally train the classification system 100, or may be new data (e.g., varying data or drifting data) used to retrain the classification system 100.

A random subset of original feature values in the data sample is substituted with background values to generate masked data according to a masking function at block 410. In some embodiments, the background values may be equal to 0, or may be equal to the mean value of each feature. For example, in some embodiments, the classification system 100 (e.g., the masked data generator 114) may generate the masked data from the data sample 104 according to the masking function described above with reference to Equation 1.

A multi-layer perceptron (MLP) is trained to approximate class label predictions on the features of the masked data based on a first classification model at block 415. In some embodiments, the first classification model may be a decision-tree based model (e.g., GBDT). For example, in some embodiments, the classification system 100 (e.g., the decision-tree classifier 112) may train the MLP based on the first classification model according to a loss function, for example, to minimize or reduce the loss function described above with reference to Equation 2.

A guideline generator may be generated to output a Shapley value for each of the features of the masked data based on the predictions by the MLP at block 420, and the method 400 may end. For example, in some embodiments, the guideline generator (e.g., see 116 in FIGS. 1 and 2 above) may include the trained MLP based on the decision-tree based model (e.g., at block 415), and may calculate reference Shapley values based on the predictions by the trained MLP on any subset of features of the masked data, for example, according to Equation 3 described above. Accordingly, a guideline generator for the current training may be generated, and used to train the second classification model (e.g., the Shapley value predictor 120 and the classification predictor 122) based on multi-task distillation to predict Shapley values and class labels.

FIG. 5 is a flow diagram of a method 500 for training a second classification model according to an embodiment. However, the present disclosure is not limited to the sequence or number of the operations of the method 500 shown in FIG. 5, and can be altered into any desired sequence or number of operations as recognized by a person having ordinary skill in the art. For example, in some embodiments, the order may vary, some processes thereof may be performed concurrently or sequentially, or the method 500 may include fewer or additional operations.

Referring to FIG. 5, the method 500 starts, and a data sample is received at block 505. For example, in some embodiments, the classification system 100 (e.g., see FIGS. 1 and 2) may receive the data sample 104 corresponding to tabular data (e.g., sensory data), but the present disclosure is not limited thereto. The data sample 104 may be training data used to originally train the classification system 100, or may be new data (e.g., varying data or drifting data) used to retrain the classification system 100.

Masked data may be generated from the data sample by substituting a random subset of original feature values in the data sample with background values according to a masking function at block 510. In some embodiments, the background values may be equal to 0, or may be equal to the mean value of each feature. For example, in some embodiments, the classification system 100 (e.g., the masked data generator 114) may generate the masked data from the data sample 104 according to the masking function described above with reference to Equation 1.

Reference Shapley values for each feature in the masked data may be calculated according to predictions based on a first classification model at block 515. For example, in some embodiments, the first classification model may be a decision-tree based model (e.g., GBDT). In some embodiments, the first classification model may be used to train an MLP to output predictions on the masked data according to the loss function described above with reference to Equation 2. In some embodiments, the reference Shapley values may be calculated by the generated guideline generator 116 based on the predictions by the trained MLP according to Equation 3 described above.

Shapley values for each feature of the masked data may be predicted by minimizing (or reducing) a loss between the reference Shapley values and the predicted Shapley values at block 520. For example, in some embodiments, the classification system 100 (e.g., the Shapley value predictor 120) may receive the reference Shapely values at block 515, and may predict Shapley values for each feature of the masked data by minimizing or reducing the distillation loss described above with reference to Equation 4.

A class label for the data sample may be predicted based on the predicted Shapely values and a ground truth class label for the data sample at block 525, and the method 500 may end. For example, in some embodiment, the classification system 100 (e.g., the classification predictor 122) may receive the predicted Shapley values at block 520 (e.g., from the Shapley value predictor 120), and may predict the class label based on the predicted Shapley values. The classification system 100 (e.g., the classification predictor 122) may receive the ground truth class label 102, and may reduce a difference between the ground truth class label 102 and the predicted class label according to a loss function, for example, by minimizing the cross-entropy loss described above with reference to Equation 5.

FIG. 6 is a graph illustrating model decision explanations output by a second classification model according to an embodiment. In more detail, FIG. 6 may illustrate an example of explanations output in the context of classifying high income and low income individuals based on various features of the individuals from a publicly available tabular data set.

Referring to FIG. 6, the graph illustrates various features of individuals on the Y-axis, such as relationship, marital status, number of years of education, capital gain, age, and the like, and Shapley values predicted for each of the features of the individuals based on various data samples. The vertical line on the right of the graph indicates the feature's value in the models determination for classifying the individual as high income (e.g., towards the top) or low income (e.g., towards the bottom).

According to one or more embodiments of the present disclosure, the Shapley values predicted by the second classification model (e.g., the Shapley value predictor 120) during training, may also be output as the explanations used to explain the model's classification decisions. For example, in some embodiments, the explanations may be output by plotting the predicted Shapley values for different data samples of different individuals in graph form as illustrated in FIG. 6, but the present disclosure is not limited thereto.

As illustrated in FIG. 6, the Shapley values predicted by the second classification model (e.g., the Shapley value predictor 120) may provide explanatory information on the more impactful features (e.g., relationship, marital status, number of years of education, capital gain, and age) that ultimately influenced the classification predictions of high income individuals versus those features (e.g., workclass, country, race, hours worked per week, and occupation) that ultimately influenced the classification predictions of low income individuals. Further, as shown in FIG. 6, sample-level as well as group-level explanations may be easily determined from the Shapley values predicted by the second classification model (e.g., the Shapley value predictor 120) that ultimately influenced the classification prediction (e.g., by the classification predictor 122).

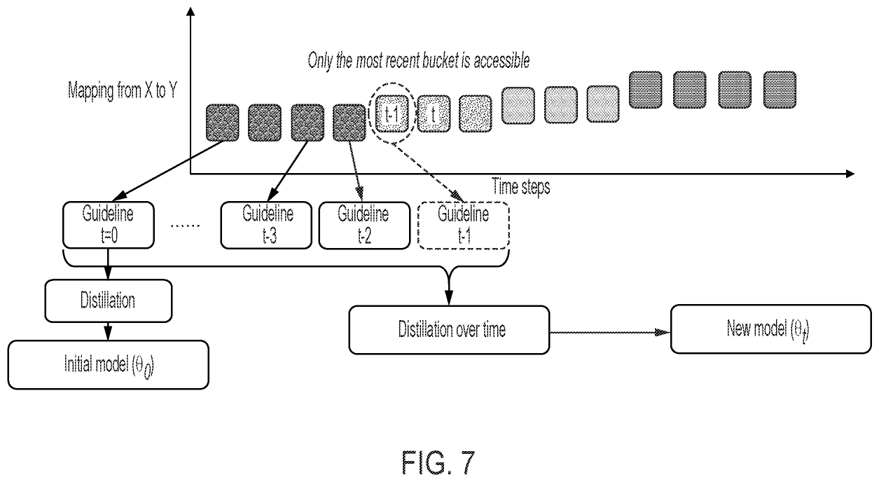

FIG. 7 is a chart schematically illustrating a method for adapting to data drift according to an embodiment.

Referring to FIG. 7, a plurality of time sequential data buckets are illustrated as square-shaped objects. The data bucket labeled with t represents the most recent data bucket that is available, and the prior data buckets (e.g., t−1, t−2, and the like) are historical data that are no longer available and/or accessible. The first data bucket corresponding to t=0 represents the original training data that was used to originally train the classification system 100, and each subsequent data bucket thereafter represents the new data (e.g., at the corresponding retraining time), which may correspond to actual production data samples, used when periodically (or incrementally) retraining the classification system 100. In other words, each of the data buckets may represent the new data at the time for the corresponding retraining time period (e.g., a retraining time step) that was used to retrain the classification system. In some embodiments, only the data from the current data bucket t is available and/or accessible for the current training period, and the data from the previous data buckets (t−1, t−2, t−3, t=0, and the like) may no longer be available and/or accessible.

As shown in FIG. 7, over time, due to differing conditions (e.g., equipment and/or processing conditions) the data (e.g., the production data) may vary or drift over time, such that it may be desirable to periodically retrain the classification system 100 over time. However, to ensure performance on the old data is maintained or substantially maintained, and because data drift may occur in both directions (rather than the one direction illustrated in the example of FIG. 7), all of the historical data (e.g., the previous data buckets) may typically be needed for each training time period, in order to retrain the system on the old data while training on the new data. In some embodiments, rather than maintaining all of the old data (e.g., the previous data buckets), only the current data bucket t (e.g., the new data) may be available and/or accessible during the current training time period.

For example, in some embodiments, as illustrated in FIG. 7, at each training time period, a guideline generator may be generated based on the data used for training during that time period, and the guideline generator may provide the knowledge needed to generate the reference Shapley values for any subset of features of the data for that time period, such that the second classification model (e.g., the Shapley value predictor 120) may distill (e.g., through the distillation loss) the knowledge from the guideline generators to predict its Shapley values. Thus, when the data drifts or varies over time, because a new guideline generator may be generated based on predictions of the first classification model on the drifting or varying data, and because the previously generated guideline generators (e.g., Guideline t−1, t−2, t−3, and the like) that may already be trained on the old data for their respective time steps may be accumulated over time, the new guideline generator may only need to worry about the features of the drifting or varying data, while the previously generated guideline generators may provide the knowledge needed for the old data (e.g., the historical data). In other words, rather than retraining the second classification model on all of the training data (e.g., including all of the historical data and the new data) for each new training period, the guideline generators generated at each training time period may be accumulated and used together to train or retrain the second classification model over time to perform the multi-distillation tasks through the respective loss functions.

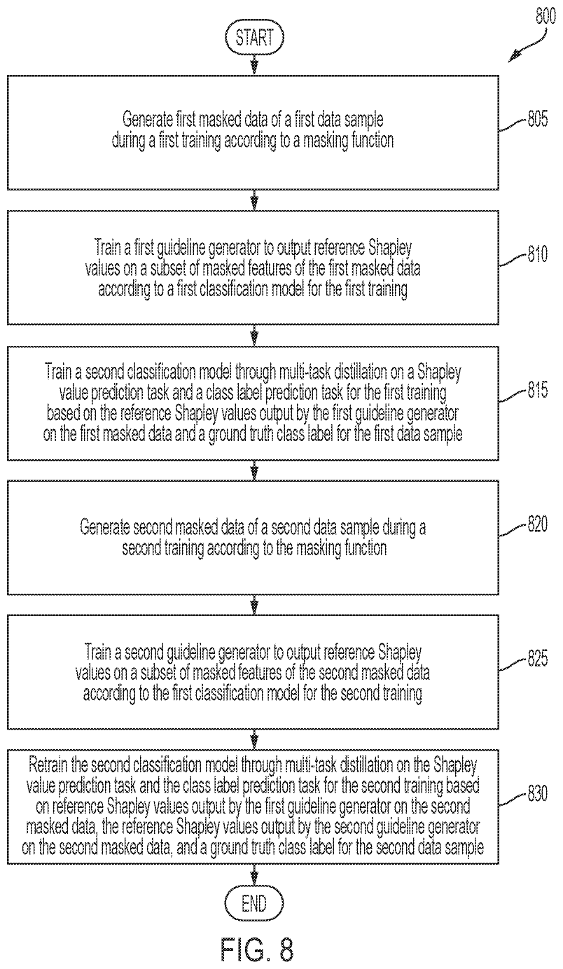

FIG. 8 is a flow diagram of a method 800 for continual learning for a classification system according to an embodiment. However, the present disclosure is not limited to the sequence or number of the operations of the method 800 shown in FIG. 8, and can be altered into any desired sequence or number of operations as recognized by a person having ordinary skill in the art. For example, in some embodiments, the order may vary, some processes thereof may be performed concurrently or sequentially, or the method 800 may include fewer or additional operations.

Referring to FIG. 8, the method 800 starts, and first masked data of a first data sample is generated during a first training according to a masking function at block 805. For example, in some embodiments, the classification system 100 (e.g., the masked data generator 114) may generate the first masked data from the first data sample according to the masking function described above with reference to Equation 1. In some embodiments, the masked data generator 114 may generate the first masked data by substituting a random subset of original feature values in the first data sample with background values according to the masking function. In some embodiments, the background values may be equal to 0, or may be equal to the mean value of each feature.

A first guideline generator is trained to output reference Shapley values on a subset of masked features of the first masked data according to a first classification model for the first training at block 810. In some embodiments, the first guideline generator may be obtained based on the first classification model (e.g., GBDT) to output the reference Shapley value for each of the features of the first masked data of the first data sample based on the predictions by a first MLP. For example, in some embodiments, the first guideline generator may include the first MLP that is trained (e.g., by the decision-tree classifier 112) based on a decision-tree based model (e.g., GBDT) to output predictions on any subset or combination of features (e.g., including masked features) of the first masked data generated based on the first data sample (e.g., according to the loss illustrated in Equation 2 above). In some embodiments, the first guideline generator may calculate the reference Shapley values based on the predictions by the first MLP, for example, according to Equation 3 above.

A second classification model is trained through multi-task distillation on a Shapley value prediction task and a class label prediction task for the first training based on the reference Shapley values output by the first guideline generator on the first masked data and a ground truth class label for the first data sample at block 815. For example, in some embodiments, the second classification model may include at least three FC layers that are trained to predict Shapley values for any subset of masked features of the first masked data based on the reference Shapley values output by the first guideline generator on the first masked data, and at least one (e.g., one or two) FC layer(s) that is trained to predict a class label for the first data sample (e.g., from which the first masked data is generated) based on the predicted Shapley values on the first masked data and the ground truth class label for the first data sample.

In some embodiments, the Shapley values for each feature in the first masked data may be predicted by minimizing (or reducing) a loss between the reference Shapley values and the predicted Shapley values. For example, in some embodiments, the classification system 100 (e.g., the Shapley value predictor 120) may receive the reference Shapely values for the first masked data from the first guideline generator, and may predict Shapley values for each feature of the first masked data by minimizing or reducing the distillation loss described above with reference to Equation 4.

In some embodiments, the class label for the first data sample may be predicted based on the predicted Shapely values and a ground truth class label for the first data sample. For example, in some embodiment, the classification system 100 (e.g., the classification predictor 122) may receive the predicted Shapley values for the first masked data (e.g., from the Shapley value predictor 120), and may predict the class label based on the predicted Shapley values. The classification system 100 (e.g., the classification predictor 122) may receive the ground truth class label, and may reduce a difference between the ground truth class label and the predicted class label according to a loss function, for example, by minimizing the cross-entropy loss described above with reference to Equation 5.

Second masked data of a second data sample is generated during a second training according to the masking function at block 820. For example, in some embodiments, the classification system 100 (e.g., the masked data generator 114) may generate the second masked data from the second data sample according to the masking function described above with reference to Equation 1. In some embodiments, the masked data generator 114 may generate the second masked data by substituting a random subset of original feature values in the second data sample with background values according to the masking function. In some embodiments, the background values may be equal to 0, or may be equal to the mean value of each feature. The second training may be a subsequent retraining of the classification system, for example, based on varying data or drifting data, and thus, may be distinct and subsequent in time from the first training. In some embodiments, the first data sample available during the first training may not be available during the second training.

A second guideline generator is trained to output reference Shapley values on a subset of masked features of the second masked data according to the first classification model for the second training at block 825. In some embodiments, a second MLP may be trained similarly to (e.g., the same or substantially the same as) that of the first MLP described above, except that the second MLP may be trained on the second masked data for the second data samples without the benefit of the first masked data or the first data sample. In other words, in some embodiments, the second guideline generator may be obtained based on the first classification model (e.g., GBDT) to output the reference Shapley value for each of the features of the second masked data of the second data sample based on the predictions by the second MLP. For example, in some embodiments, the second guideline generator may include the second MLP that is trained (e.g., by the decision-tree classifier 112) based on the decision-tree based model (e.g., GBDT) to output predictions on any subset or combination of features (e.g., including masked features) of the second masked data generated based on the second data sample (e.g., according to the loss illustrated in Equation 2 above). In some embodiments, the second guideline generator may calculate the reference Shapley values based on the predictions by the second MLP, for example, according to Equation 3 above.

The second classification model is retrained through multi-task distillation on the Shapley value prediction task and the class label prediction task for the second training based on reference Shapley values output by the first guideline generator on the second masked data, the reference Shapley values output by the second guideline generator on the second masked data, and a ground truth class label for the second data sample at block 830, and the method 800 may end. For example, in some embodiments, the second classification model may include at least three FC layers that are trained to predict the Shapley values for any subset of masked features of the second masked data based on the reference Shapley values output by the first and second guideline generators on the second masked data, and at least one (e.g., one or two) FC layer(s) that is trained to predict class labels for the second data samples (e.g., from which the second masked data is generated) based on the predicted Shapley values on the second masked data and the ground truth class label for the second data sample.

In some embodiments, the Shapley values for each feature in the second masked data may be predicted by minimizing (or reducing) a loss between the reference Shapley values and the predicted Shapley values. For example, in some embodiments, the classification system 100 (e.g., the Shapley value predictor 120) may receive the reference Shapely values for the second masked from the first and second guideline generators, and may predict Shapley values for each feature of the second masked data by minimizing or reducing the distillation loss described above with reference to Equation 4.

In some embodiments, the class label for the second data sample may be predicted based on the predicted Shapely values and a ground truth class label for the second data sample. For example, in some embodiment, the classification system 100 (e.g., the classification predictor 122) may receive the predicted Shapley values for the second masked data (e.g., from the Shapley value predictor 120), and may predict the class label based on the predicted Shapley values. The classification system 100 (e.g., the classification predictor 122) may receive the ground truth class label, and may reduce a difference between the ground truth class label and the predicted class label according to a loss function, for example, by minimizing or reducing the cross-entropy loss described above with reference to Equation 5.

In other words, during the second training, the second classification model may distill the knowledge learned by the first guideline generator during the first training based on the first data sample without requiring the first data sample during the second training, and may distill the knowledge learned by the second guideline generator based on the second data sample of the second training, for example, by reducing or minimizing the distillation loss described above with reference to Equation 4, while jointly reducing or minimizing the cross-entropy loss described above with reference to Equation 5. Accordingly, the second classification model may be periodically retrained as needed or desired, for example, by accumulating the trained guideline generators at each training/retraining period, rather than accumulating the data used to train the classification system at each training/retraining period.

According to one or more embodiments of the present disclosure, sensory data in the form of measurement data may be gathered during the manufacturing processes of display panels, and the sensory data may be analyzed to identify repairable and unrepairable defects during the manufacturing processes of the display panels. For example, during the manufacturing processes of a display panel, various sensory data may be measured from various sensors and collected in the form of tabular data, and the tabular data may be analyzed and classified into repairable and unrepairable defects by utilizing the second classification model's prediction of a defect class of a display panel given the sensor measurements and manufacturing process information for that corresponding defect. In some embodiments, Shapley values may be predicted for each feature of the sensory data, and the predicted Shapley values may provide insight to human inspectors on the root cause of the classified defects of the display panels. In some embodiments, human inspectors or engineers may validate and interpret the second classification model's behavior based on the predicted Shapley values (e.g., as the model's explanations), for example, such as what features may lead to the verdict of the defect of the display panel being classified as repairable or unrepairable. In some embodiments, by investigating the predicted Shapley values, for example, such as by comparing the impact of each feature indicated by the Shapley value to the expected impact of the feature based on human knowledge, the second classification model's behavior may be adjusted, for example, to output more accurate predictions.

Accordingly, according to various embodiments of the present disclosure, machine learning methods and models that are highly accurate in classifying repairable and unrepairable defects during various manufacturing processes of display panels may be provided, which may also provide qualitative and quantitative explanations for model decisions during training, and that adapt to continuously learn from new data in a deployment environment, in order to minimize or reduce costs that may be incurred as a result from inaccurately classifying a defect as being unrepairable.

While some examples of classifying repairable and unrepairable defects, and high and low income individuals have been described above, it should be understood that the present disclosure is not limited thereto. Embodiments of the present disclosure may be applied to any suitable systems and methods for classifying any suitable kind of data, for example, such as any suitable kinds of classification predictions for tabular data.

As described above, according to various embodiments, the classification system may distill knowledge learned from the first classification method or model (e.g., GBDT and the like) to train and/or retrain a second classification method or model (e.g., a neural network and the like). Accordingly, accuracy of the neural network based model may be improved based on guidance learned from the decision-tree based model, while providing a suitable framework that may be more easily incrementally updated than decision-tree based models alone.

As described above, according to various embodiments, the second classification method or model (e.g., the neural network based model) may generate the Shapley value predictions as the qualitative and quantitative explanations for the model's predictions in one forward pass during model training without requiring additional or post hoc processes. Accordingly, computational costs may be reduced, and potential issues may be identified sooner.

As described above, according to various embodiments, the second classification method or model (e.g., the neural network based model) may continually learn and adapt to new data (e.g., varying data or drifting data) by accumulating guideline generators that are trained on the data over time, while preserving the performance of the predictions of the historical data during training on the new data without requiring all of the historical data during the new training. Accordingly, costs, resources, and complexity for incrementally updating the second classification method or model based on the new data may be reduced, while maintain or substantially maintaining the performance on the historical data without requiring all of the historical data during training.

Although some embodiments have been described above, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated.

When a certain embodiment may be implemented differently, a specific process order may be different from the described order. For example, two consecutively described processes may be performed at the same or substantially at the same time, or may be performed in an order opposite to the described order.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to” or “coupled to” another element or layer, it can be directly connected to or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

It should be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A classification system comprising:
one or more processors; and
memory comprising instructions that, when executed by the one or more processors, cause the one or more processors to:
calculate reference Shapley values for features of a data sample based on a first classification model; and
train a second classification model though multi-task distillation to:
predict Shapley values for the features of the data sample based on the reference Shapley values and a distillation loss; and
predict a class label for the data sample based on the predicted Shapley values and a ground truth class label for the data sample.

2. The classification system of claim 1, wherein to calculate the reference Shapley values, the instructions further cause the one or more processors to:
generate masked data by substituting a subset of original feature values in the data sample with background values; and
train a multilayer perceptron to output predictions on the masked data based on the first classification model,
wherein the reference Shapley values are calculated based on the predictions output by the multilayer perceptron.

3. The classification system of claim 2, wherein:
the first classification model is a decision-tree based model; and
the multilayer perceptron is trained on the masked data according to the decision-tree based model and a loss function.

4. The classification system of claim 2, wherein to train the second classification model to predict the Shapley values, the instructions further cause the one or more processors to:
estimate the Shapley values for the features of the masked data; and
compare the estimated Shapley values with the reference Shapley values according to the distillation loss.

5. The classification system of claim 1, wherein to train the second classification model to predict the class label, the instructions further cause the one or more processors to:
estimate the class label for the data sample based on the estimated Shapley values; and
compare the estimated class label with the ground truth class label according to a cross-entropy loss.

6. The classification system of claim 1, wherein the second classification model comprises a plurality of fully connected layers with a linear activation function to be trained to predict the Shapley values based on the reference Shapley values and the distillation loss.

7. The classification system of claim 1, wherein the second classification model comprises at least one fully connected layer to be trained to predict the class label based on the predicted Shapley values and a cross-entropy loss.

8. The classification system of claim 1, wherein the instructions further cause the one or more processors to output the predicted Shapley values as explanations for the class label prediction.

9. A method for classifying data, comprising:
calculating, by one or more processors, reference Shapley values for features of a data sample based on a first classification model; and
training, by the one or more processors, a second classification model though multi-task distillation to:
predict Shapley values for the features of the data sample based on the reference Shapley values and a distillation loss; and
predict a class label for the data sample based on the predicted Shapley values and a ground truth class label for the data sample.

10. The method of claim 9, wherein the calculating of the reference Shapley values comprises:
generating, by the one or more processors, masked data by substituting a subset of original feature values in the data sample with background values; and
training, by the one or more processors, a multilayer perceptron to output predictions on the masked data based on the first classification model,
wherein the reference Shapley values are calculated based on the predictions output by the multilayer perceptron.

11. The method of claim 10, wherein:
the first classification model is a decision-tree based model; and
the multilayer perceptron is trained on the masked data according to the decision-tree based model and a loss function.

12. The method of claim 10, wherein the training of the second classification model to predict the Shapley values comprises:
estimating, by the one or more processors, the Shapley values for features of the masked data; and
comparing, by the one or more processors, the estimated Shapley values with the reference Shapley values according to the distillation loss.

13. The method of claim 9, wherein the training of the second classification model to predict the class label comprises:
estimating, by the one or more processors, the class label for the data sample based on the estimated Shapley values; and
comparing, by the one or more processors, the estimated class label with the ground truth class label according to a cross-entropy loss.

14. The method of claim 9, wherein the second classification model comprises a plurality of fully connected layers with a linear activation function to be trained to predict the Shapley values based on the reference Shapley values and the distillation loss.

15. The method of claim 9, wherein the second classification model comprises at least one fully connected layer to be trained to predict the class label based on the predicted Shapley values and a cross-entropy loss.

16. The method of claim 9, further comprising outputting, by the one or more processors, the predicted Shapley values as explanations for the class label prediction.

17. A classification system comprising:
a first machine layer perceptron to be trained to output predictions on first masked data of a first data sample during a first training based on a first classification model;
a first guideline generator to be trained to calculate reference Shapley values based on the predictions by the first machine layer perceptron during the first training; and
a second classification model to be trained though multi-task distillation during the first training to:
predict Shapley values for features of the first masked data based on the reference Shapley values and a distillation loss; and
predict a class label for the first data sample based on the predicted Shapley values and a ground truth class label for the first data sample.

18. The classification system of claim 17, wherein the second classification model comprises:
a plurality of fully connected layers with a linear activation function to be trained to predict the Shapley values based on the reference Shapley values and the distillation loss; and
at least one fully connected layer to be trained to predict the class label based on the predicted Shapley values and a cross-entropy loss.

19. The classification system of claim 17, further comprising:
a second machine layer perceptron to be trained to output predictions on second masked data of a second data sample during a second training based on the first classification model; and
a second guideline generator to be trained to calculate reference Shapley values based on the predictions by the second machine layer perceptron during the second training,
wherein the second data sample comprises data that is different from data of the first data sample, and the second training is subsequent in time from the first training.

20. The classification system of claim 19, wherein the second classification model is configured to be retrained though multi-task distillation for predicting the Shapley values and the class label during the second training based on the reference Shapley values output by the first and second guideline generators according to the first and second machine layer perceptrons, and a ground truth class label for the second data sample.
